(19) United States
(12) Patent Application Publication
(10) Pub. No.: US 2021/0144016 A1
(43) Pub. Date: May 13, 2021

(54) Method for Carrying Out Permission-Dependent Communication Between at Least one Field Device of Automation Technology and an Operating Device

(71) Applicant: KROHNE Messtechnik GmbH, Duisburg (DE)

(72) Inventor: Wolfgang Hottgenroth, Essen (DE)

(21) Appl. No.: 17/092,517

(22) Filed: Nov. 9, 2020

(30) Foreign Application Priority Data
Nov. 7, 2019 (DE) 10 2019 130 067.3

(51) Int. Cl. H04L 9/32; H04L 29/06; H04L 9/08

(52) U.S. Cl. CPC H04L 9/3268; H04L 63/123; H04L 9/0894; H04L 9/0866; H04L 9/3247; H04L 9/3236

(57) ABSTRACT

A method for permission-dependent communication between a field device of automation technology and an operating device. The method includes: in the event that the operating device has permission from a permission provider to communicate with the field device, storing on the operating device a cryptographic verification datum which is dependent on the field device identifier; receiving at the operating device the field device identifier from the field device in preparation for communication with the field device; using a cryptographic comparison step to check whether the verification datum depends, in an unambiguous manner, on the field device identifier which the operating device has received from the field device; and using the operating device to communicate with the field device only in the event that the verification datum depends, in an unambiguous manner, on the field device identifier which the operating device has received from the field device.

### TECHNICAL FIELD

The invention relates to a method for carrying out permission-dependent communication between at least one field device of automation technology and an operating device, wherein the field device and the operating device are connected to one another via a communication link and wherein the field device has an electronic field device identifier.

### BACKGROUND

Field devices in automation technology are usually various sensors or actuators that are installed “in the field”, i.e. in a technical process, where they receive measured values, output control variables or act as actuators to actively influence the process. Such field devices are thus in direct contact with a technical process, for example in a production plant. Field devices of the type mentioned here are used, for example, to measure flow rates, pressures, temperatures, pH values and other process-relevant variables or to influence the process, for example by triggering control valves.

The field devices under consideration here can be connected to an operating device via a communication link. The operating device can then be used to receive data from the field device or to influence the field device, for example by transmitting certain parameters to the field device or by enabling and/or configuring functionalities in the field device.

For various reasons, it may be desired that a certain operating device should not contact a connected field device or may only enter into communication with the field device to a certain extent. For example, the field device must meet certain safety-related requirements and therefore requires reliable protection. However, it is also possible that only certain functionalities of the field device are intended for access by an operator interface, for example by purchasing certain function blocks. For example, the operating device can be an external device with a so-called Device Type Manager (DTM).

A solution known from the state of the art for an operating device or a software component operated on the operating device only being able to enter into a communication link with a certain connected field device in a certain way consists, for example, in that the operating device is designed device-specifically and thus can only enter into a communication link with certain field devices in a certain way. The access possibility of the respective operating device to certain field devices is compiled directly into the software equipment of the operating device. Other solutions require that the operating device must be connected to a license server at runtime in order to query certain authorizations. Both solutions are complex, since in the first case an individual software must be generated for the operating device and in the second case a connection to a license server must be established.

### SUMMARY

The object of the present invention is to find the simplest possible solution for allowing an operating device to enter into a communication link with a field device in communication link only within a certain scope of permission.

In the method described above for carrying out permission-dependent communication between the field device and the operating device, the previously derived and described object is achieved in that, if the operating device has permission from a permission provider to communicate with the field device, cryptographic verification data that is dependent on the field device identifier is stored on the operating device, and the operating device receives the field device identifier from the field device in preparation for communication with the field device, in that it is checked in a cryptographic comparison step whether the verification date uniquely depends on the field device identifier that the operating device received from the field device, and that if the verification datum uniquely depends on the field device identifier that the operating device received from the field device, the operating device communicates with the field device, otherwise it does not communicate with the field device.

The permission provider can be, for example, the manufacturer of the operating device and/or the field device who wants to ensure that the operating device can only be operated in connection with certain field devices or that a certain software component of the operating device can be operated in connection with certain field devices.

A correlation between the operating device and its access to the field device is achieved by storing a cryptographic verification datum on the operating device that depends on the field device identifier. The field device identifier can, for example, consist of a serial number or a unique identifier of the field device in the installed process. A cryptographic verification datum refers to information that has been processed using encryption—i.e. cryptographic.

If the field device and the operating device are connected to each other or will be connected to each other via a communication link, the operating device first receives its field device identifier from the field device. In the cryptographic comparison step, encryption methods are then used to check whether the verification datum uniquely depends on the field device identifier, i.e. on the field device identifier that the operating device received from the field device. It is not necessary to recognize whether the field device identifier is contained in the verification datum in plain text, because it does not have to be in plain text. What is also meant, is that the verification datum can be determined indirectly, i.e. by using the field device identifier, and thus it is recognized whether the received field device identifier is contained in the verification datum in any way also cryptographically concealed. If it is determined in this sense that the verification datum is unambiguously dependent on the field device identifier, i.e. on the field device identifier that the operating device received from the field device, i.e. the comparison step is positive, it is decided in the operating device that it can communicate with the field device; if the cryptographic comparison step is negative, the operating device or the affected software component on the operating device cannot communicate with the field device. Based on the result of the cryptographic comparison step, the operating device decides whether it can communicate with the connected field device or not. However, this is completely sufficient for many applications in industrial practice.

If the operating device has no permission to communicate with the field device, it is of course still possible that a cryptographic verification datum is stored on the operating device, but this is not dependent on the corresponding field device identifier. In this case, the cryptographic comparison step can still be carried out, but it will then have a negative result so that the operating device cannot communicate with the field device.

According to a preferred design of the method, it is provided that a first license key with a cryptographic license algorithm is calculated as verification datum depending on the field device identifier and depending on a secret key. This calculation can be done, for example, on a license server on which it is known which field device with which field device identifier is to be accessible by an operating device via a communication link. The secret key is usually known to the permission provider, in particular the manufacturer of the operating device and/or the manufacturer of a communication software to be executed on the operating device for communication with the field device.

In a preferred design of the above-mentioned method, it is provided that the cryptographic license algorithm performs the calculation of a hash value from a combination of the field device identifier and the secret key.

According to a further development of the method, the secret key is stored on the operating device. This can be done in plain text, but especially protected, for example in the compiled communication software of the operating device or in another encrypted form.

In a further development of the method, a second license key with the cryptographic license algorithm is calculated in the cryptographic comparison step depending on the field device identifier received from the field device and depending on the secret key stored on the operating device. In order to prove whether the verification datum uniquely depends on the field device identifier that the operating device received from the field device, it is then checked whether the first license key matches the second license key.

Preferably, the calculation of the second license key is performed on the operating device. Alternatively, the calculation can also be performed on a computer connected to the operating device.

The design example shows that the required unambiguous dependence of the verification datum on the field device identifier that the operating device received from the field device does not necessarily mean that the field device identifier is “contained” in the verification datum, in the sense that the field device identifier must be obtainable in plain text from the verification datum. The calculation of a hash value depending on a field device identifier is a suitable means to prove that the verification datum unambiguously depends on the field device identifier, i.e. on the field device identifier the operating device received from the field device.

According to an alternative design of the method, i.e., as an alternative to the use of a secret key, it is provided that a digital certificate is created as the verification datum, wherein the digital certificate comprises, in a first certificate part, a public cryptographic key of the permission provider as well as the at least one field device identifier of those field devices for which the operating device received or is to receive permission to communicate. In a second certificate part, the digital certificate comprises a digital signature calculated from the first certificate part, wherein the digital signature is calculated with a private cryptographic certificate key of an asymmetric cryptographic certificate key pair.

While the first design of the method based on a private key is essentially suitable for assignment of an operating device to a single field device or a software component on an operating device to a single field device, the certificate solution now being discussed is also suitable for assignment to several field devices.

The digital certificate can preferably also be issued by the permission provider, i.e. in particular by the manufacturer of the operating device and/or the manufacturer of a communication software to be executed on the operating device for communication with the field device. However, this is not necessary. Alternatively, the digital certificate can also be created by a Certification Authority (CA) different from the permission provider, as is known from certificates in the field of internet communication, for example.

In a further development of the certificate-based method, it is provided that in the cryptographic comparison step on the operating device, the at least one field device identifier contained in the digital certificate is determined and the at least one determined field device identifier is compared with the at least one field device identifier obtained from the field device. If the field device identifiers match, proof is provided that the verification datum depends in an unambiguous manner on the field device identifier. In this case, the operating device can communicate with the connected field device.

In this context, a particularly preferred design of the method provides that the public certificate key of the asymmetric cryptographic certificate key pair is transmitted to the operating device and the integrity of the certificate is verified with the public certificate key on the operating device. If the verification result is negative, communication between the operating device or the software component of the operating device and the connected field device is barred and/or, if the verification result is negative, corruption of the certificate is displayed and/or reported further.

### BRIEF DESCRIPTION OF THE DRAWINGS

In detail, there is now a plurality of possibilities for designing the method according to the invention for carrying out permission-dependent communication between at least one field device of automation technology and an operating device. Corresponding further developments are described in the following on the basis of illustrated embodiments.

FIG. 1 schematically illustrates the general method for carrying out permission-dependent communication.

FIG. 2 schematically illustrates an implementation of the method according to the invention using a license key which is calculated depending on the field device identifier and a secret key.

FIG. 3 schematically illustrates a design of the method according to the invention based on a digital certificate.

### DETAILED DESCRIPTION

All three figures show a method 1 for carrying out a permission-dependent communication 2 between at least one field device 3 of automation technology and an operating device 4. The field device 3 and the operating device 4 are connected via a communication link 5. The communication link 5 can be a wired connection, but it can also be implemented via a radio interface. It can be a standardized interface, but also a connection using, for example, a manufacturer-specific, proprietary device interface; this is not important here. In any case, the field device 3 has an electronic field device identifier IDF. Such field device identifiers can be issued, for example, by the manufacturer; alternatively or additionally, unique field device identifiers IDF can also be defined by the user of the field device; this is not important here either.

With the described methods 1, it should be possible to implement a permission-dependent communication 2 between the field device 3 and the operating device 4 with very simple means, e.g., without a connection to a license server being necessary or without the operating device 4 and/or the field device 3 having to be operated with device-specific software.

Common to all described methods 1 is that in the case that operating device 4 has or is to receive permission from a permission provider 6 to communicate with the field device 3, a cryptographic verification datum VDL dependent on the field device identifier IDF_L is stored on the operating device 4. The field device identifier is referred to here as “IDF_L” and not only as “IDF” to distinguish where the field device identifier is present. The field device identifier IDF is located on the field device 3 itself in the embodiments. The field device identifier IDF_L, on the other hand, is the field device identifier that is present, for example, on the permission provider 6. If IDF and IDF_L match, communication between the field device 3 and the operating device 4 should be established, otherwise it should not. In any case, the cryptographic verification datum VDL is such that it is the bearer of the permission for communication. Furthermore, it is provided that the operating device 4 receives the field device identifier IDF from the field device 3 in preparation for communication with the field device 3. In a cryptographic comparison step 9, it is checked whether the verification datum VDL clearly depends on the field device identifier IDF that the operating device 4 received from the field device 3. The cryptographic comparison step 9 is carried out in all embodiments on the operating device 4. In case the verification datum VDL depends in a unique way on the field device identifier IDF, the operating device 4 can communicate with the field device 3, otherwise it cannot communicate with the field device 3. The internal verification on the operating device 4 therefore determines whether the operating device 4 or a software component operated on the operating device 4 can use the communication link 5 to communicate with the field device 3.

That the cryptographic verification datum VDL depends on a field device identifier is indicated in FIG. 1 in that the verification datum VDL is a function f of the field device identifier IDF_L. As already explained above, the abbreviation IDF is not used for the field device identifier but the abbreviation IDF_L is used to make clear that the field device identifier IDF located on the field device 3 can be different from the field device identifier IDF_L—this is knowledge of the permission provider 6 in the configurations shown here. Thus, if the field device identifier IDF_L is the identifier of the field device which is to be granted authorization to communicate with a certain operating device, the field device identifier IDF is the field device identifier of the field device that is actually connected.

In all representations, the cryptographic comparison step 9 takes place on the operating device 4 and is represented there as a hashtag. In FIG. 1 it is checked in general whether the verification datum VDL depends in a unique manner on the field device identifier IDF. This can be the case, for example, if the field device identifier IDF is contained in plain text in the verification datum VDL. However, this is only one possible variation and does not have to be implemented in this manner. More generally, only one distinct dependency of the verification datum VDL from a field device identifier IDF to be checked is required so that it can be checked whether communication should be allowed with the field device 3 with the identifier IDF by the operating device 4 or not.

The embodiment in FIG. 2 already makes clear what is meant in that the field device identifier IDF need not be contained in plain text in the verification datum VDL. In FIG. 2 it is shown that, as verification datum VDL, a first license key is calculated with a cryptographic license algorithm f, namely depending on the field device identifier IDF_L and depending on a secret key KEY. In this case, the secret key KEY is known to the permission provider 6 who is, for example, the manufacturer of the operating device 4 or may also be the manufacturer of communication software for execution in the operating device 4 for communication with the field device 3.

In the embodiment shown in FIG. 2, the cryptographic license algorithm f performs the calculation of a hash value from a combination of the field device identifier IDF_L and the secret key KEY.

In the case of the method 1 shown in FIG. 2, the secret key KEY is stored on the operating device 4. This makes it possible to perform the cryptographic comparison step 9 on the operating device 4. In the cryptographic comparison step 9, a second license key VDF=f(IDF, KEY) is calculated with the cryptographic license algorithm f depending on the field device identifier IDF received from the field device 3 and the secret key KEY stored on the operating device 4. To verify whether the field device identifier IDF received from the operating device 4 is contained in the verification datum VDL, it is checked whether the first license key VDL matches the second license key VDF=f(IDF, KEY). The check for the match of the license keys can be positive (pos) and thus result in allowing communication, but it can also be negative (neg) and thus result in a blocking of the communication between the operating device 4 and the field device 3.

In practice, it is the case that the secret key KEY and the verification datum VDL are transmitted to the operating device 4 at different times. The secret key KEY is preferably stored such that it cannot be changed (or can only be changed with “factory privileges”) during production or during manufacture when the device is “christened”, while the verification datum VDL is preferably stored such that it can be changed in the operating device 4 after commissioning of the operating device 4 in the field or during customer-specific provisioning of the operating device 4 in the factory.

The embodiment of the method 1 shown in FIG. 3 is an alternative implementation to the implementation shown in FIG. 2 using a secret key. The alternative solution shown in FIG. 3 works with digital certificates. Thus, a digital certificate ZERT is created as the verification datum VDL. The digital certificate ZERT comprises, in a first certificate part, a public cryptographic key PUBL of the permission provider 6 as well as the field device identifier IDF_L or the field device identifiers IDF_L1, IDF_L2 of those field devices for which the operating device 4 is to receive permission to communicate. In a second certificate part, the digital certificate ZERT comprises a digital signature SIGN_PRIVZ calculated from the first certificate part. The digital signature is calculated—as usual for certificates—with a private cryptographic certificate key PRIVZ of an asymmetric cryptographic certificate key pair PUBZ, PRIVZ. This key pair is usually issued by a certification authority. It can be an authority completely independent of the permission provider 6, but of course the permission provider 6 (for example in the form of the manufacturer of the operating device 4 and/or the field device 3 and/or a communication software for the operating device 4) can also work as a certification authority.

In the cryptographic comparison step 9, the at least one field device identifier IDF_L contained in the digital certificate ZERT is determined 10 on the operating device 4. In the present case, two field device identifiers are contained in the digital certificate ZERT, namely the field device identifiers IDF_L1 and IDF_L2. The determined field device identifiers IDF_L1, IDF_L2 are compared with the field device identifiers IDF1, IDF2 obtained from field device 3. If the field device identifiers IDF1, IDF2, IDF_L1, IDF_L2 match, proof is provided that the respective field device identifiers IDF1, IDF2 received by the operating device 3 are contained in the verification datum VDL and insofar the verification datum VDL depends in an unambiguous way on the field device identifier IDF. Accordingly, the communication between the operating device 4 and the field device 3 or the field devices 3 is enabled or disabled.

In FIG. 3, it can also be seen that the public certificate key PUBZ of the asymmetrical cryptographic certificate key pair PUBZ, PRIVZ has been transmitted to the operating device 4. The public certificate key PUBZ is used on the operating device 4 to check the integrity of the certificate ZERT. This is an additional check to the check in comparison step 9. If the result of the check is negative, communication between the operating device 4 and at least one field device 3 is also barred. Alternatively or additionally it could be provided that, in case of a negative verification result, a corruption of the certificate ZERT is indicated and/or reported.

In practice, it is the case that the public key PUBZ—like the secret key KEY in FIG. 2—is already stored in the operating device 4 in an unchangeable form (or can only be changed with “factory privilieges”) during production. The associated private key PRIVZ is kept secret by the permission provider. The permission VDL consists of the public key PUBL which is signed together with the device identifiers IDF_L with the private key PRIVZ of the permission provider 6. The triplet PUBL, IDF_Ln, SIGN_PRIVZ is then used to form the verification datum VDL. The verification datum VDL can be verified with the help of the public key PUBZ. The verification datum VDL is preferably stored such that it can be changed in the operating device 4 after commissioning the operating device 4 in the field or during customer-specific provisioning of the operating device 4 in the factory.

1. A method for carrying out permission-dependent communication between at least one field device of automation technology and an operating device, wherein the field device and the operating device are connected to one another via a communication link and wherein the field device has an electronic field device identifier, the method comprising:
in the event that the operating device has permission from a permission provider to communicate with the field device, storing on the operating device a cryptographic verification datum which is dependent on the field device identifier;
receiving at the operating device the field device identifier from the field device in preparation for communication with the field device;
using a cryptographic comparison step to check whether the verification datum depends, in an unambiguous manner, on the field device identifier which the operating device has received from the field; and
using the operating device to communicate with the field device only in the event that the verification datum depends, in an unambiguous manner, on the field device identifier received from the field device.

2. The method of claim 1, further comprising calculating as verification datum a first license key with a cryptographic license algorithm in dependence on the field device identifier and in dependence on a secret key.

3. The method of claim 2, further comprising using the cryptographic license algorithm to carry out the calculation of a hash value from a combination of the field device identifier and the secret key.

4. The method of claim 2, further comprising storing the secret key on the operating device.

5. The method of claim 2, further comprising:
calculating a second license key in the cryptographic comparison step with the cryptographic license algorithm in dependence on the field device identifier obtained from the field device and in dependence on the secret key stored on the operating device; and
to prove whether the verification datum depends, in an unambiguous manner, on the field device identifier, checking whether the first license key matches the second license key.

6. The method of claim 5, further comprising carrying out the calculation of the second license key on the operating device.

7. The method of claim 1, further comprising generating a digital certificate as the verification datum;
wherein, in a first certificate part, the digital certificate contains a public cryptographic key of the permission provider and the at least one field device identifier of those field devices, for which the operating device has permission to communicate; and
wherein, in a second certificate part, the digital certificate includes a digital signature calculated from the first certificate part, wherein the digital signature is calculated with a private cryptographic certificate key of an asymmetric cryptographic certificate key pair.

8. The method of claim 7, wherein the digital certificate is generated by at least one of a manufacturer of the operating device and a manufacturer of a communication software for execution on the operating device for communication with the field device.

9. The method of claim 7, further comprising:
determining the at least one field device identifier contained in the digital certificate in the cryptographic comparison step on the operating device;
comparing at least one determined field device identifier with the at least one field device identifier; and
in the case of matching field device identifiers, providing proof that the verification datum unambiguously depends on the field device identifier, since the relevant field device identifier, at least one of which is obtained from the operating device, is contained in the verification datum.

10. The method of claim 7, further comprising:
transmitting the public certificate key of the asymmetric cryptographic certificate key pair to the operating device; and
verifying the integrity of the certificate with the public certificate key on the operating device;
wherein, in the event of a negative check result, the method further comprises at least one of: excluding communication of the operating device with the at least one field device; and indicating corruption of the certificate.

11. The method of claim 4, wherein the secret key is stored in the compiled communication software on the operating device.

12. The method of claim 8, further comprising:
determining the at least one field device identifier contained in the digital certificate the cryptographic comparison step on the operating device;
comparing at least one determined field device identifier with the at least one field device identifier; and
in the case of matching field device identifiers, providing proof that the verification datum unambiguously depends on the field device identifier, since the relevant field device identifier, at least one of which is obtained from the operating device, is contained in the verification datum.
